(19) United States
(12) Patent Application Publication
(10) Pub. No.: US 2003/0061075 A1
(43) Pub. Date: Mar. 27, 2003

(54) System and method for rating and structuring bands of crop production insurance

(75) Inventors: Roger Heckman, Laguna Niguel, CA (US); Catherine Besselman, Rancho Santa Margarita, CA (US); Bill Fischer, Fargo, ND (US); Bin Zhang, Irvine, CA (US); James Tran, Santa Ana, CA (US)

Correspondence Address: OSTROLENK FABER GERB & SOFFEN, 1180 AVENUE OF THE AMERICAS, NEW YORK, NY, 100368403

(73) Assignee: CONVERIUM REINSURANCE (NORTH AMERICA) INC.

(21) Appl. No.: 10/151,488

(22) Filed: May 17, 2002

Related U.S. Application Data
(60) Provisional application No. 60/291,565, filed on May 17, 2001.

(51) Int. Cl. G06F 17/60

(52) U.S. Cl. 705/4

(57) ABSTRACT

A method of providing insurance coverage for a producer, the method comprising: receiving producer input data, identifying an insured value for an amount of production; and defining one or more bands of coverage for the producer based on the input data and the insured value, each band of coverage including an upper limit and a non-zero lower limit.

### CROSS REFERENCE TO RELATED APPLICATIONS

This application claims the benefit and priority of U.S. Provisional Patent Application No. 60/291,565, filed May 17, 2001, entitled “SYSTEM AND METHOD FOR OPTIMIZING THE REVENUE OPPORTUNITIES OF A PRODUCER”, the entire disclosure of which is incorporated herein by reference.

### BACKGROUND OF THE INVENTION

The present invention relates to a system and method for agriculture risk management. More particularly, the present invention relates to a system and method for providing insurance coverage for an agricultural producer, and in particular, wherein the producer is insured over at least one band of agricultural production. The invention further relates to a system and method for calculating an insurance premium for such insurance protection over at least one band of agricultural coverage. The system and method are implemented in computer hardware and software.

Farmers face risks of adverse events, including drought, frost, disease, insects, hail, floods, fire, windstorms, etc., which has the potential of reducing crop yields and/or quality. To provide financial protection, farmers often use crop insurance as a part of their risk management program.

Crop insurance is a heavily regulated industry. Insurance agents must comply with many regulations regarding the sale of crop insurance.

The acreage and production information required to underwrite crop insurance policies is grouped by an insurance term called a “unit”. These unit groupings are used by the insurance company and the Federal Crop Insurance Corporation (FCIC) to calculate premium, liability, and claim payments. A unit may contain several fields owned and/or operated by the same farmer. The production history of these fields are used to calculate the insured's Actual Production History (APH), which is also maintained on a unit-basis. APH is a measure of an individual farmer's annual production of a commodity over a multi-year period. The APH serves as the basis for the farmer's “normal” crop yield in the crop insurance program. When the actual crop yield deviates by falling more than a certain percentage from the APH, an insured producer is eligible for an indemnity (loss) payment. The calculation of each unit's APH must meet many underwriting regulations as established by the FCIC. The APH has a significant impact on the insured's premium, liability, and loss processing.

The total production of all fields contained within a unit is used to calculate potential loss payments. For example, if a farmer chooses to purchase coverage at a level of 75% of the unit's APH, the farmer will only receive a loss payment if the total actual and/or appraised production is less than 75% of the insured's coverage. Therefore, a farmer could have 25 acres of a 100 acre unit totally destroyed by hail, but would not be in a loss situation if the other 75 acres met or exceeded their APH for the given unit.

Consequently, when several fields are grouped into one unit, the company's risk for potential claims is reduced because damage in one field may be offset by harvested production in excess of the unit's APH from other fields comprising the unit. Therefore, it is generally in the best interests of the farmer to have as many units as possible, and it is generally in the best interests of the insurance company and the FCIC to have as few units as possible.

There are four basic types of crop insurance: Multi-Peril Crop Insurance, Crop Hail Insurance, Private Company “Weather” Insurance and Private Multi-Peril “Add-Ons”. Basically, all of these types of insurance protect farmers from crop losses due to natural hazards.

Multi-Peril Crop Insurance

Multi-Peril Crop Insurance is ordinarily available in five general forms: A. Straight Multi-Peril, B. Catastrophic (“CAT”), C. Crop Revenue Coverage (“CRC”), D. Income Protection (“IP”) and E. Group Risk Plan (“GRP”). Multi-Peril gets its name because it covers basically any naturally caused loss including Drought (55%), Excess Moisture(16%), Frost/Freeze(11%), Hail(8%), Wind(3%), Plant Disease(3%), Flood(2%), Insects(1 %), and other causes such as Wildlife (1%). The percentages indicate that particular peril's share of crop losses.

All of these types of Multi-Peril Crop Insurance are federally subsidized through an agency known as the FCIC (Federal Crop Insurance Corporation). These programs are administered through private insurance companies which sell insurance and maintain records based on laws as set forth by Congress and administrative rules as set forth by the FCIC. These programs are a combination of the private insurance companies' funds and federal funds. Federal funds subsidize the actual cost of the farmer's premium, about 30%. Federal monies also guarantee payable losses as well as paying the private companies an administrative fee. This arrangement of using the private sector to sell and maintain these programs was set up 20 or 30 years ago but changes were made in the early 80's in an effort to entice more farmers to use crop insurance.

The FCIC has several functions. It establishes premium rates and produces what is known as county actuarials for each crop sold in the county. It also sets the maximum price for each crop. Setting, changing, adding and deleting various administrative rules is also a function of the FCIC.

The Straight Multi-Peril plan is by far the largest type of crop insurance sold. Its premise is that it guarantees bushels of production based on the farmer's actual historical average. There are two widespread misconceptions about straight multi-peril. One is that the ground/production is lumped together if one has a claim. The other is that one must use established ASCS/CFSA yields. These misconceptions are far from the truth. In the past few years new rules have made the establishment of units and creating actual production history much easier.

Catastrophic insurance is the low end form of multi-peril coverage that was the minimum required in 1995 in order to be eligible for farm programs. Most farmers purchased it through their local ASCS/CFSA office for $100.00 per crop. The coverage level was 50% and the price was 60% of the maximum. It has no unit breakup, except by share one can supply actual yield history, but because the coverage is so low and there are few units, most farmers just used ASCS yields.

Crop Revenue Coverage (CRC) is another form of Multi-Peril Crop Insurance. It closely resembles the Straight Multi-Peril plan in that it utilizes units, but, in addition to covering low harvest yields, there is also price protection.

Depending on the crop type and the geographical (state) location where it's grown, the price (base and harvest) is based on an average of each day's closing price for a particular month. CRC is an alternative type of insurance from the Straight Multi-Peril plan or GRP (discussed below). However, one cannot buy CRC in conjunction with Straight Multi-Peril or GRP. Basically, CRC is just like the Straight Multi-Peril plan in that it is a continuous policy. The same dates are used that dictate when coverage must be applied for or changed/canceled. Premiums are due at the same time and the premiums and losses are calculated on the farmer's share of the unit.

Some of the disadvantages of CRC are that with comparable coverage levels, the CRC premium is more expensive than the Straight Multi-Peril plan. Also, in some case scenarios, the farmer could receive less indemnity under CRC as compared to Straight Multi-Peril. This could happen if the Straight Multi-Peril market price was set higher than the CRC base price.

Income Protection (IP) is another form of Multi-Peril Crop Insurance. It closely relates to CRC, except it cannot be broken up into units. The IP program uses a combination of actual production history (APH) and a futures average. A dollar amount of coverage per acre is what is covered, not a guarantee of a specific number of bushels per acre like Multi-Peril. Production does not have to be below a certain number of bushels to trigger a claim, it only has to be under a certain dollar amount per acre. However, unlike Straight Multi-Peril, if there are poor yields and if the price goes up, there may not be any eligibility for a claim. Another disadvantage to IP is that “overall” yield is used, and individual unit catastrophes that are covered in Straight Multi-Peril are not necessarily covered with IP.

Group Risk Plan (GRP) insurance covers natural perils but is vastly different from the other forms of Multi-Peril coverage discussed above. Currently it is only available for corn, soybeans and wheat in most states. It differs from the other multi-peril forms in that individual crop production does not enter the picture. This means that if a farmer produces 50 bushels of corn, he might not collect a dime under GRP if the overall county yield was above the a set amount. The ability to assert a claim is dependent upon the county yield average as set by a national statistical service. For this type of insurance, a farmer selects a percent of the set county average for that year and a price to be paid. If the county average drops below what the farmer has selected, he has a claim.

Crop Hail Insurance

Hail coverage is most commonly referred to as “Basic Hail”. This type of coverage has been around for 50 to 75 years. This coverage is written by private companies and is un-subsidized. Though each company may have a few differences in coverage, a traditional basic hail policy covers hail and fire—most often stored grain and grain in transport is also covered. Basically, a farmer selects a dollar amount of coverage per acre and if hail or fire occurs, adjusters calculate a percent of loss and pay the farmer that percent times the dollar amount selected.

Many farmers have hail insurance. They traditionally like it because it's been around a long time and record keeping is easy. Also hail damage is dramatic—seeing a nice field of corn ripped apart by hail in August is very upsetting—you cannot see until harvest what dry/hot weather is doing to corn pollination, in contrast.

Private “Weather” Insurance

There are many types/forms of this insurance offered by many private companies. Chiefly, a farmer bets against the insurance company that a certain number of inches of rain will fall before a specific date, or that it will not frost before a specific date. This insurance is most often used by specialty crop farmers such as vegetable or seed corn producers.

Private Multi-Peril “Add-Ons”

Many companies that write Straight Multi-Peril policies have additional optional coverages that dovetail with the Straight Multi-Peril policies. Most often a farmer must have Straight Multi-Peril coverage in order to apply for these add-ons. These add-ons are completely private and are not federally subsidized. Many farmers use these add-ons as protection against crop forward-contracting. Normally if they contract a high percent of their expected yield and if their yield comes up short they must pay the difference. With this coverage, a farmer selects the crop(s) he wants to cover and a price he wants to be paid (within limits). If the farmer's yield is below 65% of the unit's average, he is paid the price per bushel selected times the number of bushels short.

One of the major drawbacks to the above types of insurance is that the insurance pays out to a farmer only when production falls below the certain percentage insured.

### SUMMARY OF THE INVENTION

The present invention provides a system and method of calculating an insurance premium for a producer based on an insured value, the method comprising defining a band of coverage having an upper and a lower limit, determining an expected yield for the band of coverage, simulating an expected loss for the band of coverage based on the expected yield; and calculating the insurance premium based on the expected loss and the insured value.

According to the invention, the method further comprises calculating a band of coverage in units of production per land area by subtracting the lower limit from the upper limit and multiplying the result thereof by the expected yield.

The invention further includes the step of calculating a pure rate for the band of coverage by dividing the expected loss by the band coverage. The step of calculating the insurance premium comprises multiplying together the band of coverage, the pure rate and the insured value. The insurance premium may be calculated by multiplying the expected loss by the insured value. The insurance premium can be calculated for more than one band of coverage.

According to another aspect, the invention comprises a method of providing insurance coverage for a producer, the method comprising receiving producer input data, identifying an insured value for an amount of production; and defining one or more bands of coverage for the producer based on the input data and the insured value, each band of coverage including an upper limit and a non-zero lower limit.

The present invention also relates to a revenue optimization system that is in communication with a producer input module or station so as to receive producer input data. The revenue optimization system comprises a hedging strategy module, a revenue optimization module, one or more client databases and one or more historical databases. The revenue optimization system further includes, or is connected to, an insurance policy preparation module.

In operation, the revenue optimization system of the present invention receives specific producer input data from the producer input module, forwards the data to the hedging strategy module wherein a hedging strategy based on the input data is calculated. Then, the hedging strategy module output is forwarded to the revenue optimization module wherein one or more price and yield outcomes are calculated for the producer so as to optimize the producer's revenue opportunities. The present system and method provides for the revenue optimization of a producer based on that producer's specific data and provides a recommendation on a series of products, that when purchased, serve to provide an overall minimum level of revenue for the producer.

The present system and method affords a producer the complete ownership of his/her production output so that the producer can benefit from any upward market price movements. The various components of the present system form safety nets to keep revenue at its highest. However, since they are packaged together, there is a greater incentive to produce as much as possible so that maximum gains in revenue can be realized, and little incentive for moral hazard as to production, care and maintenance of the growing crop. Traditional individual stand-alone products cannot provide this integrated protection.

The present system and method is an entirely new approach to production agriculture risk management. It is a comprehensive agriculture risk management package that optimizes a producer's revenue opportunities by suggesting the most efficient mix of revenue insurance (both private and federally subsidized), hedging and merchandising. The present system and method eliminates the weaknesses of having stand alone risk management products by combining the comparative advantages from three different risk vehicles: revenue insurance, futures markets and grain merchandising.

Unlike other individual insurance products, the present system and method provides the producer with a bundled risk management tool that protects him/her from yield risk and allows for the opportunity to capitalize on market movements. It gives producers flexibility on who they deliver to, while also building in merchandising gains.

Also, the present invention requires a minimum amount of producer information to generate a producer specific rate for each band of coverage to be calculated.

### BRIEF DESCRIPTION OF THE DRAWINGS

The invention will be described in greater detail in the following detailed description with reference to the accompanying drawings in which:

FIG. 1 is a block diagram of the revenue optimization system of the present invention;

FIG. 2 is a block diagram of the revenue optimization module of the system shown in FIG. 1.

### DETAILED DESCRIPTION OF EMBODIMENTS OF THE INVENTION

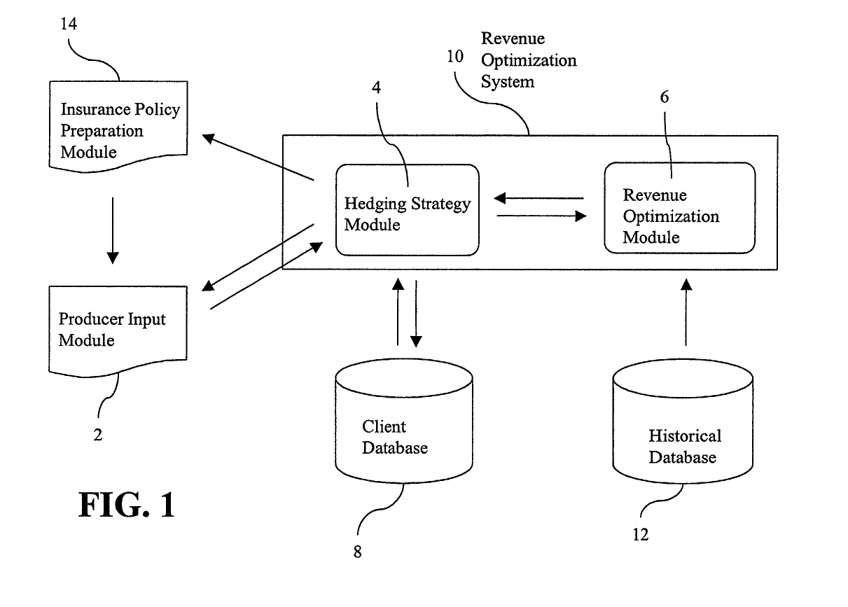

Referring now to the drawings, the present system is shown in general block-diagram form in FIG. 1. As shown in FIG. 1, the revenue optimization system 10 is in communication with a producer input module 2 or station so as to receive producer input data. The revenue optimization system 10 comprises a hedging strategy module 4, a revenue optimization module 6, one or more client databases 8 and one or more historical databases 12. The revenue optimization system 10 further includes, or is connected to, an insurance policy preparation module 14. Each of these system components and their operation will be discussed in further detail below.

The present invention is preferably designed to operate in a web-based or Internet-based format. With this, it is contemplated to have at least a portion of the system of the present invention resident on the hardware of a client-server system, or at least a portion provided in the form of software, such as a CD or the like, to provide access from remote user terminals. Accordingly, if the present system is implemented in a web-based environment, it will be evident that any of the modules discussed herein can be in different physical locations without interfering with the operation or utility of the system.

The present system and method provides for the revenue optimization of a producer based on that producer's specific data and provides a band of coverage, which, if the actual yield of the producer falls within, pays an indemnity to the producer. As a brief example, assume a particular producer has an expected yield of 128.7 bushels/acre and has purchased a 70-90% band of coverage (90.1-115.8 bushels/acre) at an insured value of $2.10/bushel. With a 70-90% band of coverage, this producer is covered for the difference between his actual yield and the upper band limit multiplied by the insured value. If the producer has an actual yield of 102 bushels/acre, the indemnity due to the producer given the above numbers would be (115.8-102 bushels/acre)* $2.10/bushel=$28.98/acre. If the actual yield falls below the lower band limit, the entire band is payable. For example, if the producer has an actual yield of 80 bushels/acre, the indemnity due the producer would be (115.8-90.1 bushels/acre)* $2.10/bushel=$53.97/acre.

With the above in mind, each of the components and their operation will now be discussed in detail.

Producer Input Module or Station

Preferably, the present system is implemented through a network communication such as the Internet. With that, a user or producer will access the revenue optimization system 10 via a user terminal 2, typically a personal computer, PDA, or other similar input device. However, if the present system is implemented as a dedicated system, the input terminal may be embodied as an input module which communicates and transfers the input producer data to the other modules within the system.

When the user terminal 2 connects to the revenue optimization system 10, an interactive producer input screen/form is displayed. The input form/screen prompts the producer for the input of data elements used within the revenue optimization system 10. The producer input data may include location information (state and county), crop identification, practice information (irrigated, non-irrigated, etc.), acreage, actual production history data, estimated production amount, production cost per acre, fall delivery basis, spring delivery basis, storage costs, number of months of storage, current type of insurance product being used along with its coverage level and interest rate, or any combination thereof.

Preferably, the producer provides the revenue optimization system 10 with six (6) to ten (10) years of Actual Production History (APH) data on his/her farm's total acres grown in a county for a selected crop and practice (irrigated, non-irrigated, all practice types, etc.). The producer's APH includes the actual farm yield for each year. The producer, however, does not need to input NASS (USDA/National Agricultural Statistical Service) county yield data. This data is preferably obtained by the present system through one or more embedded or linked historical databases 12 which will be discussed in greater detail below. Accordingly, once the specific state-county-crop-practice (irrigated, non-irrigated, all practice types, etc.) is input by the producer, a corresponding NASS data set is obtained by the present system for use in the revenue optimization calculations described below.

Revenue Optimization System

A. Hedging Strategy Module (ARM)

The producer input data received from the producer is then used to calculate a hedging strategy by the hedging strategy module 4. As is commonly known, there is no particular formula for calculating a hedging strategy. Preferably, however, a hedging strategy is calculated wherein the positions established are above an insured or elected selling price of the producer's crop (typically, this is the price established in CRC insurance).

The hedging strategy module 4 combines the benefits of sound marketing (and hedging) and the protection of revenue insurance to provide the producer with a minimum level of revenue per acre prior to planting. This module preferably utilizes standard spreadsheet programs, such as Microsoft Excel, to calculate the hedging strategy. The hedging strategy module 4 basically functions similar to the Allendale Risk Management Program (ARM), which was developed by Allendale, Inc. in 1996 in response to the Farm Act. The Allendale Risk Management Program is incorporated herein by reference.

The ARM program uses a variety of tools, including regulated contracts to establish a target price, a sale price and areas through which a producer can collect “deficiency revenue” to bring total revenue to acceptable levels. ARM locks in a base revenue per acre (not per bushel), so as to establish a profit margin.

The ARM program is designed to protect farmers from adverse weather risks, droughts (high prices/low yields) and overproduction (low prices/average yields), and not to optimize the farmer's revenue in all market conditions. The drawbacks to the ARM program include that the farmer's income will decline in years of little risk, and the less volatile the market, the less the benefit obtained by the farmer. Since the ARM program is well known, it will not be described in detail herein.

The hedging strategy module 4 takes the producer input data, including the APH data, retrieves further client data from the one or more client databases 8, and calculates hedging revenues under fall and/or spring deliveries, hedging costs under fall and/or spring deliveries, and net gross income ($/acre) under different yield and price assumptions or scenarios. The hedging strategy module 4 then compares the scenario results with and without the ARM program to arrive at the worst net gross income scenario. Preferably, the hedging strategy module includes a processor that carries out the above calculations. This processor is preferably an IC device or the like.

The one or more client databases 8 contain data such as the producer's name, address, identification number (social security number, or the like), and any combination thereof. These client databases are either internal databases or are separate external databases which are accessed and queried by the present system based on the producer's input data. In either situation, the client databases 8 return additional information about the producer to the revenue optimization system 10. After the hedging strategy module performs its calculations, it sends the updated data to the one or more client databases so that the information contained therein is the most up to date information.

Also, if the information input by the producer is not complete in that the hedging strategy module cannot perform its calculations, the system preferably prompts the producer to input the missing data or required data. This procedure can be repeated as many times as needed until all the required information is received from the producer.

B. Revenue Optimization Module

Because the use of hedging strategies alone have certain drawbacks as described above, the revenue optimization system 10 of the present invention takes the output of the hedging strategy module and performs further calculations so as to optimize the producer's revenue opportunities.

The revenue optimization module 6 utilizes the output of the hedging strategy module 4 (one or more hedging strategies) and the data from the one or more historical databases 12 to calculate one or more price and yield outcomes for particular bands of coverage for the producer so as to optimize the producer's revenue opportunities. Preferably, the one or more price and yield outcomes calculated are output and integrated into an optimization spreadsheet, which is presented to the producer. This output of the revenue optimization module 6 preferably contains one or more combinations of price and yield, in $/acre, and arranged according to a particular band of coverage for the producer according to his/her specific producer input data.

Preferably, the revenue optimization module 6 exists on the same server as the hedging strategy module 4 and includes its own processor, or shares the same processor as the hedging strategy module. Simultaneous with receiving the hedging strategy module 4 output, the revenue optimization module 6 preferably accesses the one or more historical databases 12 to retrieve data specific to the producer's input data. As stated above, the historical databases 12 contain NASS county yield data and are either internal databases or separate external databases which are accessed and queried by the present system. The revenue optimization module 6 generates a listing of all combinations of price and yield outcomes for particular bands of coverage for a single producer, beginning with the worst (lowest) revenue scenario and ending with the best (highest). Similar to the hedging strategy module, the revenue optimization module can repeat the above processes of receiving the hedging strategy module output and accessing the one or more historical databases until all data required to perform the calculations is obtained.

In the preferred embodiment, the revenue optimization module 6 establishes the one or more price and yield outcomes for particular bands of coverage by 1) developing an insurance yield for each insured crop, 2) determining the deductible amount of that yield and 3) calculating the amount of yield that will be protected by the policy. Preferably, the minimum deductible is 10% of the expected production and the maximum amount of coverage is 90% of expected production. However, a producer may choose to insure any amount of production from 0-90% of expected yield and may select any size deductible amount. For example, a corn farmer with an expected production of 100 bushels per acre may select to insure 25% with a deductible of 15% (i.e., a “band” from 60%-85%). This farmer would be due an indemnity if his harvested production was less than 85 bushels per acre and would be due the total amount of the insurance if his yield were less than or equal to 60 bushels per acre.

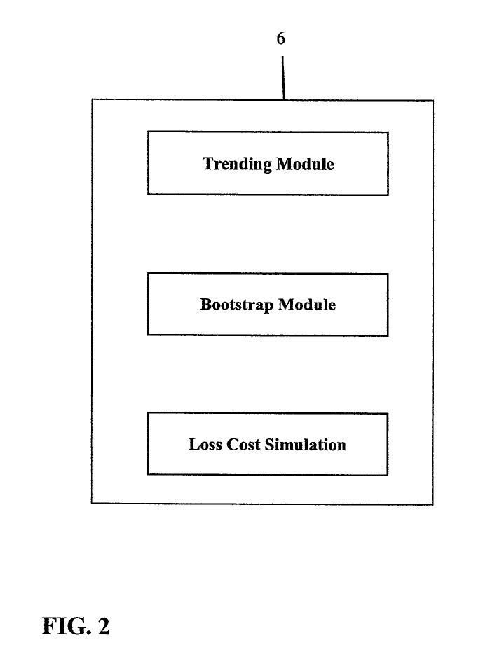

To calculate the one or more price and yield outcomes for particular bands of coverage, the revenue optimization module 6 initiates three procedures, 1) a trending procedure, 2) a bootstrapping procedure and 3) a loss/cost estimation procedure. The details of each of these procedures will be outlined below. Each of these procedures can be embodied in its own module present within the revenue optimization module as shown in FIG. 2. Because each of these procedures are capable of being embodied in their own module, they can each have their own independent processor. Alternatively, they can share a processor.

The Trending Procedure

The trending procedure includes three steps, a farm level yield analysis, a county yield trending analysis and a calculation of expected farm yield for any particular producer based on the producer's specific data.

### Step 1. Farm Yield Analysis

A producer's farm yield analysis is preferably calculated as follows:

Y_{ft}=f(T)+ε_{ft}

wherein:

Y_{ft} is the weighted average farm yield for total acres grown in a county

(e.g. Bu/acre) at year t;

T is the year index;

ε_{ft} is a white-noise term for the farm yield; and

f is a function form.

The function form is designed to show a statistical relationship between the yield (Y_{ft}) and the year index (T). The function form f can take two forms, linear and non-linear. An example of a linear form is Y=a+b*T, and an example of a non-linear form is Y=cT^{d}, where a, b, c, and d are constants and/or estimated parameters. Preferably, the linear function form is Y=−500+2.55T and the non-linear form is Y 3.15T^{0.032}. The numbers in the equations may vary from farm to farm based on the average yield levels and yield variations.

In utilizing the above equation to calculate the farm trending yield, a statistical significance test is preferably used to select the best-fit trending model based on a 95% confidence level. In particular, a linear trending model is preferred. When the trending is not statistically significant at a 95% confidence level as measured by a standard student t test, a zero trending is preferable.

### Step 2. County Yield Trending Analysis

As stated above, a producer does not need to input NASS county yield data because the revenue optimization module has embedded therein, or is linked to, one or more historical databases that contain data on all products and prices for a crop, sorted and categorized by region, and historical data related to that crop. Basically, these databases contain the Federal Government's data on crop production and are maintained by the FCIC. These databases also contain the rates for federally subsidized crop revenue insurance.

Accordingly, once a specific state-county-crop-practice (irrigated, non-irrigated, and all practice) is selected by the buyer, a corresponding NASS data set is retrieved by the revenue optimization module for the county yield trending analysis. For each county, a long yield history (varying from 25-30 years of NASS data) is preferably used to estimate a county-level yield trending model.

The historical databases 12 can be either internal databases which are embedded within the present system, or they can be external databases which are maintained by either the entity operating the present system or an entirely separate entity, such as the Federal Government or an agency thereof. The data from the historical databases 12 can be obtained by enabling direct access to the records of the database, wherein a query of the data is performed and the results transferred to the revenue optimization module. Also, the data from the historical databases 12 can be obtained by submitting a request to the entity that maintains the data records contained therein, wherein that entity performs the search and returns the results to the system of the present invention.

The county-level yield trending analysis is preferably performed with the following equation:

Y_{ct}=f(T)+δ_{ct}

wherein:

Y_{ct} is the county yield (e.g. Bu/acre) at year t;

T is the year index;

ε_{ct} is the white-noise term for county yield; and

f is a function form.

Similar to the farm yield analysis, the function form is designed to show a statistical relationship between the yield (Y_{ct}) and the year index (T). The function form f can take two forms, linear and non-linear. An example of a linear form is Y=a+b*T, and an example of a non-linear form is Y=cT^{d}, where a, b, c, and d are constants and/or estimated parameters. Preferably, the linear function form is Y=−500+2.55T and the non-linear form is Y=3.15T ^{0.032}. The numbers in the equations may vary from county to county based on the average yield levels and yield variations.

A statistical significance test is preferably used to select the best-fit trending model for each county-crop combination at a 95% confidence level. A student t test is also preferably conducted to validate the county yield trend at the 95% confidence level. Preferably, a linear trending analysis is utilized.

### Step 3. Calculation of Expected Farm Level Yield

Once the farm yield analysis and the county yield trending analysis are performed, a trend-adjusted yield series will be estimated for both the farm yield and county yield. Preferably, traditional econometric trend-adjusting procedures are used. The below trending-adjustment equation is preferably used to estimate the trend-adjusted yield series for both the farm and county yields:

Yₜᵣ₋ₜ=Yₜ+(T−t)*Trending Drift

wherein:

Yₜᵣ₋ₜ is the trend-adjusted yield for year t (expected farm yield for year t);

T is the yield for the last (latest) year in the series;

t is the yield for the year to be analyzed; and

Trending Drift is an econometric term that is the estimated coefficient for the year index in the trending models above.

For example, if the yield data runs from 1980-1999, then the T will be the 1999 yield and the small t will be the yield from any one of the years from 1980 to 1999. Using the results of the above equation, a set of farm level expected yields are estimated by using a weighted average of the two trending drifts (i.e., the trend-adjusted yield for the farm and the trend-adjusted yield from the county). The expected farm yield is estimated as a simple average of the set of farm level expected yields.

The Bootstrapping Procedure

Bootstrapping is an econometric process developed in the 1950s. It is widely used to conduct statistical significance tests for estimated parameters from econometric models. Normally, it establishes a statistical or economic relationship between several variables and uses that relationship equation to simulate more observations for statistical analyses.

Preferably, the bootstrapping procedure of the present invention is the same bootstrapping process used by the USDA/RMA (Risk Management Agent) in their development of the FCIC Income Protection (IP) program described above. The detailed application procedures can be found in a USDA publication, “Income Protection”, Technical Report, USDA/ERS 43-3AEK-5-8, Feb. 16, 1996, the contents of which are incorporated herein by reference. This bootstrapping process establishes a statistical relationship between the farm and county yield history. The underlying assumption in the process is that a farmer's production variability can be decomposed into (1) the variability common to all farms in the county (i.e., county variability) and (2) the residual variability remaining after the county variability is expunged from the total farm level variability due to the farm-specific production characteristics.

A bootstrapping equation is used to simulate farm level yields (farm level sampling) beyond the 6-10 historical data points provided by the producer. This equation can be described as:

$$\begin{matrix}Farm Yield Sampling = Predicted County Yield \\ + \text{Farm-County Yield Variability} \\ Decomposition \\ + County Yield Variability \\ + Farm Yield Variability\end{matrix}$$

The Predicted County Yield is based on the county trending analysis described above using the actual NASS county yield data. The bootstrap process then applies the results of the county trending analysis to predict (recast or re-calculate) what the county yield is statistically.

With respect to the Farm-County Yield Variability Decomposition, a producer's yield variability can be decomposed into two parts (I) the part due to farm level variations (e.g., farm management) and (II) county level variations (e.g., soil type). The Farm-County Yield Variability Decomposition is calculated in three steps:

(1) Calculate the mean of county and farm yield;

(2) Calculate county and farm yield deviations from their respective means; and

(3) Calculate the difference between county and farm yield deviations. The output from step (3) is the Farm-County Yield Variability Decomposition value.

The County Yield Residual calculation is a straightforward calculation. It is calculated as the difference between the actual county yield and the predicted county yield.

The value of the Farm Yield Sampling is then generated by a random sampling or simulation process. First, the mean difference between the county and farm average yield for a selected period (preferably a minimum of 6 years) is calculated. Then, a randomly selected number from the calculated Predicted County Yield, the Farm-County Yield Variability Decomposition and the County Yield Residuals, respectively, are added to the mean difference between the county and farm average yield for the selected period. This process is preferably repeated 10,000 times until a statistically sound estimate of the farm yield average and the variability is calculated.

The Loss/Cost Estimation Procedure

The above described sampling/simulation procedures are repeated until 10,000 random farm yields are generated and these simulated yields are compared with a yield trigger defined by each band of coverage. The trigger will start at the point defined by the upper band of coverage multiplied by the farm expected yield and will not extend beyond the point defined by the lower band of coverage multiplied by the farm expected yield. For example, if the farm expected yield was 151 bushels per acre and the band of coverage is 70-90%, then the trigger will start at 136 bushels/acre (90% * 151 bushels/acre=136 bushels/acre) and not extend beyond 106 bushels/acre (70% * 151 bushels/acre=106 bushels/acre).

Thereafter an actuarial expected loss is calculated as the average payout over each band based on the 10,000 simulations. In the example described below, the expected loss for the 70-90% band is 4.3 bu/acre, and the corresponding pure rate is estimated to be 0.1431 (0.1431=4.3/30.2). The pure rate is calculated as the expected loss divided by the number of bushels/acre included within the band of coverage. The number of bushels/acre within the band of coverage is calculated by subtracting the lower band of coverage from the upper band of coverage, and then multiplying the result by the expected yield as calculated above.

Then, the cost per acre for the particular band of coverage is calculated for the farmer based on his/her specific data. The cost per acre for each band of coverage is calculated by multiplying the number of bushels within the band of coverage, the pure rate for that band of coverage and the price (in $/bushel) selected by the farmer. This cost per acre is calculated for one or more bands of coverage and represents the one or more price and yield outcomes. Then, these results are transmitted to the producer for his/her review.

After being presented with the one or more price and yield outcomes, the producer is then asked to select a desired “band” of coverage for purchase, if any. When the producer indicates that he/she wishes to purchase a particular “band” of coverage, the information regarding the producer and the selected “band” of coverage is transmitted to an insurance policy preparation module 14 for preparation of the insurance policy. The insurance policy preparation module 14 may be an integral, fully automated system that receives the relevant information electronically so as to write the policy and forward the same to the producer. It is also contemplated that the insurance policy preparation module 14 may be a person which receives the information electronically (e-mail) or physically (fax or mail), writes the policy, and forwards the same to the producer.

### EXAMPLE

The following is an example of implementation of the above described system and method. In this example, the producer, Farmer Joe, produces corn for grain in Brown County, Nebr. and his practice type is all types (irrigated, non-irrigated, etc.) Table 1 represents Farmer Joe's specific yield for the years of 1989-1998 and the county yield for Brown County for the years 1972-1998 as obtained from the NASS historical database.

TABLE 1

| | NE-Brown | |
|---|---|---|
| | County | Farmer Joe |
| | NASS Yield | Yield |
| Year | (Bu/Acre) | (Bu/Acre) |
| 1972 | 95 | |
| 1973 | 92 | |
| 1974 | 19 | |
| 1975 | 44 | |
| 1976 | 48 | |
| 1977 | 34 | |
| 1978 | 99 | |
| 1979 | 103 | |
| 1980 | 62 | |
| 1981 | 94 | |
| 1982 | 94 | |
| 1983 | 62 | |
| 1984 | 88 | |
| 1985 | 109 | |
| 1986 | 129 | |
| 1987 | 107 | |
| 1988 | 92 | |
| 1989 | 88 | 120 |
| 1990 | 106 | 140 |
| 1991 | 111 | 130 |
| 1992 | 136 | 129 |
| 1993 | 91 | 100 |
| 1994 | 132 | 130 |
| 1995 | 81 | 169 |
| 1996 | 121 | 140 |
| 1997 | 124 | 150 |
| 1998 | 132 | 160 |
| Average | 92.38 | 136.80 |
| Std | 30.69 | 19.89 |
| C.V. | 0.33 | 0.15 |

With the information input by Farmer Joe, hedging strategies are then calculated based on his specific data, using for example ARM. Thereafter, all of the foregoing information is then utilized by the revenue optimization module to calculate one or more price ($/bushel) and yield outcomes for Farmer Joe (i.e., the &/acre for a particular band of coverage, or premium). The revenue optimization module then implements the trending procedure, bootstrapping procedure and loss/cost estimation procedure described above. Table 2, Table 3 and Table 4 below represent the calculations from the farm yield analysis, the county yield trending analysis and the expected farm level yield, respectively, for Farmer Joe.

TABLE 2
Farm Yield Analysis

| | Farm Level Yield | |
|---|---|---|
| | Untrended | Trend-adjusted |
| Year | (Bu/Acre) | (Bu/Acre) |
| 1989 | 120 | 154 |
| 1990 | 140 | 171 |
| 1991 | 130 | 157 |
| 1992 | 129 | 152 |
| 1993 | 100 | 119 |
| 1994 | 130 | 145 |
| 1995 | 169 | 180 |
| 1996 | 140 | 148 |
| 1997 | 150 | 154 |
| 1998 | 160 | 160 |
| Average | 136.80 | 153.98 |
| Std | 19.89 | 16.18 |
| C.V. | 0.15 | 0.11 |

TABLE 3
County Level Trending Analysis

| | NE-Brown County | |
|---|---|---|
| | NASS Yield | |
| | | Trend- |
| | Un-Trended | Adjusted |
| Year | (Bu/Acre) | (Bu/Acre) |
| 1972 | 95 | 161 |
| 1973 | 92 | 156 |
| 1974 | 19 | 81 |
| 1975 | 44 | 103 |
| 1976 | 48 | 104 |
| 1977 | 34 | 88 |
| 1978 | 99 | 150 |
| 1979 | 103 | 152 |
| 1980 | 62 | 108 |
| 1981 | 94 | 138 |
| 1982 | 94 | 135 |
| 1983 | 62 | 100 |
| 1984 | 88 | 123 |
| 1985 | 109 | 143 |
| 1986 | 129 | 160 |
| 1987 | 107 | 136 |
| 1988 | 92 | 118 |
| 1989 | 88 | 111 |
| 1990 | 106 | 127 |
| 1991 | 111 | 129 |
| 1992 | 136 | 152 |
| 1993 | 91 | 103 |
| 1994 | 132 | 142 |
| 1995 | 81 | 88 |
| 1996 | 121 | 126 |
| 1997 | 124 | 126 |
| 1998 | 132 | 132 |
| Average | 92.38 | 125.58 |
| Std | 30.69 | 23.05 |
| C.V. | 0.33 | 0.18 |

TABLE 4
Expected Farm Level Yield

| | | | Farm Level |
|---|---|---|---|
| | Farm Level Yield | | Expected |
| | Untrended | Trend-adjusted | Yield |
| Year | (Bu/Acre) | (Bu/Acre) | (Bu/Acre) |
| 1989 | 120 | 154 | 149 |
| 1990 | 140 | 171 | 165 |
| 1991 | 130 | 157 | 152 |
| 1992 | 129 | 152 | 148 |
| 1993 | 100 | 119 | 116 |
| 1994 | 130 | 145 | 143 |
| 1995 | 169 | 180 | 179 |
| 1996 | 140 | 148 | 146 |
| 1997 | 150 | 154 | 153 |
| 1998 | 160 | 160 | 160 |
| Average | 136.80 | 153.98 | 151.14 |
| Std | 19.89 | 16.18 | 16.30 |
| C.V. | 0.15 | 0.11 | 0.11 |

Next, the bootstrapping process is implemented as described above. Table 5 illustrates the results obtained for Farmer Joe based on his specific data and the previous calculations.

TABLE 5

| | Untrended | Predicted | Farm Level | Farm-County | | |
|---|---|---|---|---|---|---|
| | County Yield | County Yield | Expected Yield | Yield Variability | County Yield | Farm Yield |
| Year | (bu/acre) | (bu/acre) | (bu/acre) | Decomposition | Residuals | Sampling |
| 1972 | 95 | 59.18 | | | 35.58 | |
| 1973 | 92 | 61.73 | | | 29.97 | |
| 1974 | 19 | 64.28 | | | −44.95 | |
| 1975 | 44 | 66.84 | | | −22.68 | |
| 1976 | 48 | 69.39 | | | −21.34 | |
| 1977 | 34 | 71.94 | | | −37.82 | |
| 1978 | 99 | 74.50 | | | 24.66 | |
| 1979 | 103 | 77.05 | | | 26.38 | |
| 1980 | 62 | 79.61 | | | −17.87 | |
| 1981 | 94 | 82.16 | | | 12.04 | |
| 1982 | 94 | 84.71 | | | 9.76 | |
| 1983 | 62 | 87.27 | | | −25.11 | |
| 1984 | 88 | 89.82 | | | −2.25 | |
| 1985 | 109 | 92.38 | | | 16.98 | |
| 1986 | 129 | 94.93 | | | 34.45 | |
| 1987 | 107 | 97.48 | | | 9.97 | |
| 1988 | 92 | 100.04 | | | −7.72 | |
| 1989 | 88 | 102.59 | 148.67 | 2.17 | −14.85 | 148.67 |
| 1990 | 106 | 105.14 | 165.49 | 0.40 | 1.19 | 165.49 |
| 1991 | 111 | 107.70 | 152.30 | −17.25 | 3.09 | 152.30 |
| 1992 | 136 | 110.25 | 148.12 | −46.93 | 26.03 | 148.12 |
| 1993 | 91 | 112.81 | 115.93 | −33.42 | −22.22 | 115.93 |
| 1994 | 132 | 115.36 | 142.74 | −47.55 | 16.17 | 142.74 |
| 1995 | 81 | 117.91 | 178.56 | 39.16 | −37.27 | 178.56 |
| 1996 | 121 | 120.47 | 146.37 | −33.57 | 0.71 | 146.37 |
| 1997 | 124 | 123.02 | 153.19 | −29.46 | 0.86 | 153.19 |
| 1998 | 131.82 | 125.58 | 160.00 | −30.58 | 6.24 | 160.00 |
| Mean | 192.38 | 92.38 | 151.14 | (19.70) | 0.00 | 151.14 |
| StD | 130.69 | 20.27 | 16.30 | 26.80 | 23.05 | 16.30 |

After the bootstrapping process is completed, the pure premium rates are calculated for each band of coverage as described above. Table 6 shows the pure premium rates (pure cost per acre, column (h)) for Farmer Joe based on his specific data. The bands of coverage used are 70-90%, 80-90% and 85-90%.

TABLE 6

| | | | | 10,000 | | | Pure |
|---|---|---|---|---|---|---|---|
| Expected | Band of | | Band | Simulated | | Price | Cost Per |
| Yield | Coverage | | Coverage | Expected Loss | | Election | Acre |
| (bu/acre) | Upper | Lower | (bu/acre) | (bu/acre) | Pure Rate | ($/bu) | ($/Acre) |
| (a) | (b) | (c) | (d) = (b − c)*a | (e) | (f) = e/d | (g) | (h) = d*f*g |
| 151 | 90% | 70% | 30.2 | 4.3 | 0.1431 | $2.55 | $11.0 |
| 151 | 90% | 80% | 15.1 | 2.7 | 0.1808 | $2.55 | $7.0 |
| 151 | 90% | 85% | 7.6 | 1.6 | 0.2065 | $2.55 | $4.0 |

Then Farmer Joe is presented with the one or more price and yield outcomes (as defined by the pure cost per acre for the particular band of coverage) and asked to select a “band” he would like. Once Farmer Joe selects a band, the above information is transmitted to the insurance policy preparation module for preparation of a corresponding insurance policy which will be forwarded to Farmer Joe. Based on these price and yield outcomes, Farmer Joe can then see how he will be insured should his production either exceed, fall in or fall below the band of coverage selected for the calculated premiums. He can then decide which band to select, and accordingly, the premium he will pay per acre.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A method of calculating an insurance premium for a producer based on an insured value, the method comprising:
defining a band of coverage having an upper and a lower limit;
determining an expected yield for the band of coverage;
simulating an expected loss for the band of coverage based on the expected yield; and
calculating the insurance premium based on the expected loss and the insured value.

2. A method as in claim 1, further comprising:
calculating a band coverage in units of production per land area by subtracting the lower limit from the upper limit and multiplying the result thereof by the expected yield.

3. A method as in claim 2, further comprising:
calculating a pure rate for the band of coverage by dividing the expected loss by the band coverage.

4. A method as in claim 3, wherein the step of calculating the insurance premium comprises multiplying together the band coverage, the pure rate and the insured value.

5. A method as in claim 1, wherein the insurance premium is calculated by multiplying the expected loss by the insured value.

6. A method as in claim 1, wherein the insurance premiums are calculated for more than one band of coverage.

7. A method as in claim 1, wherein the insured value is selected by the producer.

8. A method as in claim 1, wherein the expected yield is determined by:
calculating a county trended yield using county crop yield data;
calculating a farm yield using data specific to the producer;
estimating the expected yield based on the county trended yield and the farm yield.

9. A method as in claim 8, wherein the expected yield is estimated using a weighted average of the county trended yield and the farm yield.

10. A method as in claim 1, wherein the band of coverage comprises up to 90% of the expected yield.

11. A method as in claim 9, wherein the county trended yield is calculated as:
Y_{ct}=f(T)+ε_{ct}
wherein:
Y_{ct} is the county trended yield;
T is a year index;
f is a function form; and
ε_{ct} is white-noise term for the county crop yield at year T.

12. A method as in claim 11, wherein the county trended yield is validated using a statistical significance test for one or more county and crop combinations.

13. A method as in claim 12, wherein the statistical significance test is a linear trending model.

14. A method as in claim 12, wherein the statistical significance test is measured at a 95% confidence level.

15. A method as in claim 11, wherein the farm yield is calculated as:
Y_{ft}=f(T)+ε_{ft}
wherein:
Y_{ft} is the farm yield; and
ε_{ft} is white-noise term for actual farm yield at year T.

16. A method as in claim 15, wherein the county trended yield is validated using a statistical significance test for one or more county and crop combinations.

17. A method as in claim 16, wherein the statistical significance test is a linear trending model.

18. A method as in claim 16, wherein the statistical significance test is measured at a 95% confidence level.

19. A method as in claim 18, wherein a zero trending is used when the 95% confidence level is not statistically significant.

20. A method as in claim 8, further comprising:
initiating a bootstrapping process so as to establish a farm yield forecast based on a statistical relationship between the county trended yield and the farm yield.

21. A method as in claim 1, wherein the expected loss is simulated by:
generating a plurality of farm yields based on a yield trigger; and
calculating the expected loss as an average payout over the band of coverage based on the plurality of farm yields.

22. A method as in claim 21, wherein the yield trigger is defined by the upper limit of the band of coverage multiplied by the expected yield and the lower limit of the band of coverage multiplied by the expected yield.

23. A method of providing insurance coverage for a producer, the method comprising:
receiving producer input data;
identifying an insured value for an amount of production; and
defining one or more bands of coverage for the producer based on the input data and the insured value, each band of coverage including an upper limit and a non-zero lower limit.

24. A method as in claim 23, wherein the upper limit is up to 90% of an expected yield.

25. A method as in claim 23, further comprising:
prompting the producer to select one of the one or more bands of coverage.

26. A method as in claim 25, further comprising:
providing an insurance policy for the producer for the selected band of coverage.

27. A method as in claim 25, further comprising:
calculating an insurance premium for each band of coverage based on the insured value.

28. A method as in claim 27, wherein the premium amount is calculated by:
determining an expected yield for the band of coverage;
simulating an expected loss for the band of coverage based on the expected yield; and
utilizing the expected loss and the insured value to calculate the insurance premium.

29. A method as in claim 23, wherein the producer input data comprises at least one of location information, crop identification, practice information, acreage, and actual production history data.
